(19) United States
(12) Patent Application Publication
(10) Pub. No.: US 2008/0247476 A1
(43) Pub. Date: Oct. 9, 2008

(54) Method and Synchronizer for Fine Ofdm Symbol Synchronization and Method/Receiver for the Reception of Ofdm Symbols

(75) Inventor: Frederic Pirot, Argences (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/995,799

(22) PCT Filed: Jul. 10, 2006
(86) PCT No.: PCT/IB2006/052330

§ 371 Date: Jun. 4, 2008

(30) Foreign Application Priority Data
Jul. 20, 2005 (EP) 05300604.5

(51) Int. Cl. H04L 27/26

(52) U.S. Cl. 375/260

(57) ABSTRACT

A fine OFDM symbol synchronization method comprising the steps of: estimating (in 36) a channel impulse response (CIR) from received predetermined pilots present in OFDM symbols, the pre-determined pilots being arranged within the OFDM symbol at frequency intervals corresponding to n carrier frequencies, and their positions being shifted by k carrier frequencies from one OFDM symbol to the next, so that it is sent on the same frequency earner every m OFDM symbols, and thus m*k=n, m, n and k being integer numbers greater than one, and fine-tuning (in 60) the position of a time-domain-to-frequency-domain window used for receiving OFDM symbols, according to the position of at least one power peak in the estimated channel impulse response, wherein, if there are channel impulse response replicas in the estimated channel impulse response, the positions of correlated power peaks spaced apart by a multiple of Formula (I) is used for finding the position of the at least one power peak used n for fine-tuning, where Tu is the duration of the modulation of an OFDM symbol minus the guard interval.

### FIELD OF THE INVENTION

The present invention relates to a method and a synchronizer for fine OFDM symbol synchronization, and a method/receiver for the reception of OFDM symbols.

### BACKGROUND OF THE INVENTION

There exist fine OFDM (Orthogonal Frequency-Division Multiplexing) symbol synchronisation methods having the steps of:
estimating a channel impulse response (CIR) from received predetermined pilots present in OFDM symbols, the predetermined pilots being arranged within the OFDM symbol at frequency intervals corresponding to n carrier frequencies, and their positions being shifted by k carrier frequencies from one OFDM symbol to the next, so that m*k=n, m, n and k being integer numbers greater than one, and
fine-tuning the position of a time-domain-to-frequency-domain window used for receiving OFDM symbols, according to the position of at least one power peak in the estimated channel impulse response.

The time-domain-to-frequency-domain window is also known as FFT (Fast Fourier Transform)-Window.

The fine-tuning step is based on the position of a first high power peak in the estimated channel impulse response having a power higher than a predetermined level.

When the receiving conditions of OFDM symbols are not disrupted by parasitic effects, the estimated channel impulse response presents only power peaks matching the “real channel response”. This power peaks, called “real peaks” hereinafter correspond to the real channel impulse response. In those conditions, the existing methods work correctly.

When the receiving conditions are disrupted by some parasitic effects like Doppler effects, the estimated channel impulse response presents a plurality of power peaks. Some of those power peaks corresponds to the real channel impulse response, whereas other peaks correspond to the replicas of the real channel impulse response. The power peaks corresponding to the replicas of the real channel impulse response are known as “ghost peaks” or “replica peaks” or “image peaks”.

Under certain circumstances, some ghost peaks can be higher than the real peaks. Under these circumstances, the existing methods select a ghost peak instead of the real peak and the fine-tuning is not correct.

This problem is for example disclosed in the following reference:

<<Symbol synchronization in OFDM system for time selective channel conditions >> Arto Palin, Jukka Rinne, Digital Media Institute/Telecommunications Tampere University of Technology, IEEE 1999.

Basic knowledge of OFDM symbol synchronization can also be found in this reference.

### SUMMARY OF THE INVENTION

Accordingly, it is an object of the invention to provide a fine OFDM symbol synchronization method which performs better than the methods based on the position of the first high power peak in the estimated channel impulse response.

With the foregoing and other objects in view there is provided in accordance with the invention a fine OFDM symbol synchronization method wherein, if there are channel impulse response replicas in the estimated channel impulse response, the positions of correlated power peaks spaced apart from each other by a multiple of

$$\frac{{T}_{u}}{n}$$

is used for finding the position of the at least one power peak used for fine-tuning, where Tᵤ is the duration of the modulation of an OFDM symbol.

The correlated power peaks spaced apart by a multiple of

$$\frac{{T}_{u}}{n}$$

correspond to one real peak and to ghost peaks. The position of ghost peaks is related to the position of the real peak. Thus, the position of the correlated power peaks gives useful information to determine the position of the peak used for fine-tuning. As a result, it becomes possible to achieve correct fine-tuning even if there are ghost peaks higher than or equal to the real peaks. Therefore, it performs better than methods based on the position of the first high power peak in the estimated channel impulse response.

The embodiments of the above method may comprise one or several of the following features:
the position of each power peak used for fine-tuning is found from the positions of the x highest correlated power peaks, where x is an odd number greater than or equal to three,
each power peak used for fine-tuning is found from the position of the smallest correlated power peak which is smaller than the m−1 highest correlated power peaks,
the fine-tuning is done according to the following value:

$${P}_{L} + m / 2 \frac{{T}_{u}}{n} mod ( m \cdot \frac{{T}_{u}}{n} )$$

where:
P_{L} is the position of the smallest correlated power peak,
Tᵤ is the duration of the modulation of an OFDM symbol, and
“mod” is the symbol for the “modulo” operation.
the method comprises the step of verifying the existence of channel impulse response replicas in the estimated channel impulse response by testing the existence of correlated power peaks spaced apart by a multiple of

$$\frac{{T}_{u}}{n} .$$

The above embodiments of the terminal offer the following advantages:
using the position of the x highest correlated power peaks increases the robustness of the method;
using the position of the (m−1) highest correlated power peaks in the estimated channel impulse response makes the detection of the position of the lowest correlated power peak possible, even if the power of this peak is very small or nearly zero;
fine-tuning using the lowest correlated power peak position plus

$$m / 2 \frac{{T}_{u}}{n} mod ( m \cdot \frac{{T}_{u}}{n} )$$

achieves very good performances;
verifying the existence of channel impulse response replicas allows selecting the best way to fine-tune the FFT-window position depending on the existence or not of ghost peaks.

The invention also relates to an OFDM symbol receiving method comprising a coarse OFDM symbol synchronization step, and the above fine OFDM symbol synchronization phase.

The invention also relates to a fine OFDM symbol synchronizer comprising:
a channel impulse response estimator to build an estimated channel impulse response from received predetermined pilots present in OFDM symbols, the predetermined pilots being arranged within the OFDM symbol at frequency intervals corresponding to n carrier frequencies, their positions being shifted by k carrier frequencies from one OFDM symbol to the next one, so that m*k=n, m, n and k being integer number greater than one, and
a fine-tuner to fine-tune the position of a time-domain-to-frequency-domain window used for receiving OFDM symbols according to the position of at least one power peak in the estimated channel response, wherein the fine-tuner is adapted to use the positions of correlated power peaks spaced apart by a multiple of

$$\frac{{T}_{u}}{n}$$

to find the position of at least one power peak used for fine-tuning, where Tᵤ is the duration of the modulation of an OFDM symbol.

The embodiments of the above synchronizer may comprise one or several of the following features:
the fine-tuner is designed to find the position of each correlated power peak used for fine-tuning from the position of the x highest correlated power peaks, where x is an odd number greater than or equal to three,
the fine-tuner is designed to find the position of each correlated power peak used for fine-tuning from the position of the smallest correlated power peak which is smaller than the m−1 highest correlated power peaks, and
the fine-tuner is designed for fine-tuning according to the following value:

$${P}_{L} + m / 2 \frac{{T}_{u}}{n} mod ( m \cdot \frac{{T}_{u}}{n} )$$

where:
P_{L} is the position of the smallest correlated power peak,
Tᵤ is the duration of the modulation of an OFDM symbol, and
“mod” is the symbol for the “modulo” operation.

The invention also relates to an OFDM symbol receiver comprising:
a coarse OFDM synchronizer for coarse positioning of a time-domain-to-frequency-domain window used for receiving OFDM symbols, and
the above fine OFDM symbol synchronizer for fine positioning of the time-domain-to-frequency-domain window.

These and other aspects of the invention will be apparent from the following description, drawings and claims.

### BRIEF DESCRIPTION OF THE DRAWINGS

FIG. 1 is a schematic diagram of the structure of a mobile terminal having an OFDM symbol receiver;

FIG. 2 is a flowchart of an OFDM symbol receiving method; and

FIG. 3 is a draft of an estimated channel impulse response.

### DESCRIPTION OF THE PREFERRED EMBODIMENTS

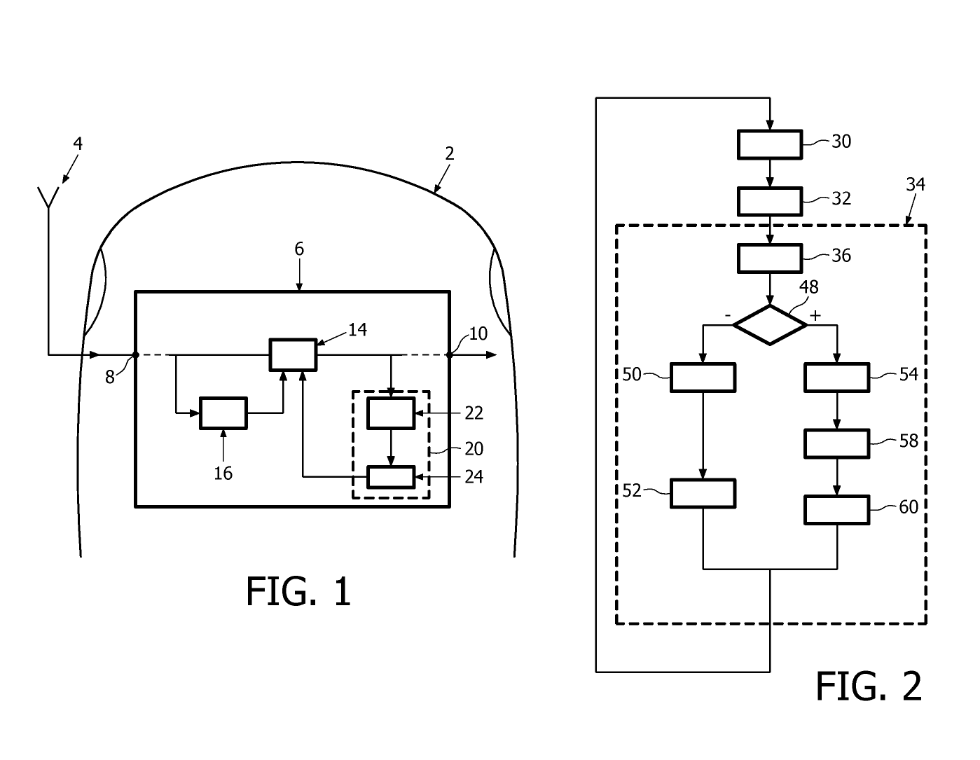

FIG. 1 shows a DVB-T (Digital Terrestrial Video Broadcasting) mobile terminal 2. For example, terminal 2 is a mobile phone.

Terminal 2 is adapted to receive wireless signals according to an OFDM communication protocol. The signal is a multi-carrier signal used for transporting OFDM symbols.

The structure of terminals to receive OFDM symbols is well known so, for simplicity, FIG. 1 shows only the details necessary to understand the invention.

Terminal 2 has an antenna 4 to receive wireless signals and an OFDM symbol receiver 6 connected to antenna 4 through an input 8. For example, receiver 6 is a radio frequency receiver which outputs a baseband signal corresponding to the received signal through an output 10.

Receiver 6 has a fast Fourier transformer 14 and a coarse synchronizer 16 inputs of which are connected to input 8.

Transformer 14 is designed to perform FFT (Fast Fourier Transform) on the received signal during an FFT-Window.

Synchronizer 16 is intended to perform a coarse OFDM symbol synchronization that consists of placing the FFT-Window accurately enough, so that post-FFT operations can be performed.

Synchronizer 16 outputs a coarse tuning instruction to tune the FFT-Window position of transformer 14.

Post-FFT operations relate to operations carried out on the symbols in the frequency domain outputted by transformer 14.

Receiver 6 has also a fine synchronizer 20 to perform fine OFDM symbol synchronization using scattered pilots present in the OFDM symbols. More precisely, pilots are predetermined symbols which are repeatedly sent in the signal, so that an estimated channel impulse response can be built by the receiver. For example, scattered pilots are continuously sent all through the reception of these signals. For instance, in DVB-T standard, one predetermined pilot is shifted by k carrier frequencies from one symbol to the next, so that it is sent on the same frequency carrier every m OFDM symbols. Within one OFDM symbol, predetermined pilots are arranged on carrier frequencies which are spaced apart by n carrier frequencies. Thus m*k n where m, k and n are integers greater than one. For example, m equals 4, k equals 3, and n equals 12. This is a well-known process and will not be described in further detail.

An input of synchronizer 20 is connected to an output of transformer 14 to receive the symbols in the frequency domain.

Synchronizer 20 has a channel impulse response estimator 22 to build the estimated channel impulse response from the scattered pilots present in the received signal and a fine-tuner 24. Fine-tuner 24 is able to fine-tune the position of the FFT-Window according to the position of the real peak in the estimated channel impulse response.

Tuner 24 outputs a fine-tuning instruction to transformer 14 to fine-tune the FFT-Window position of transformer 14.

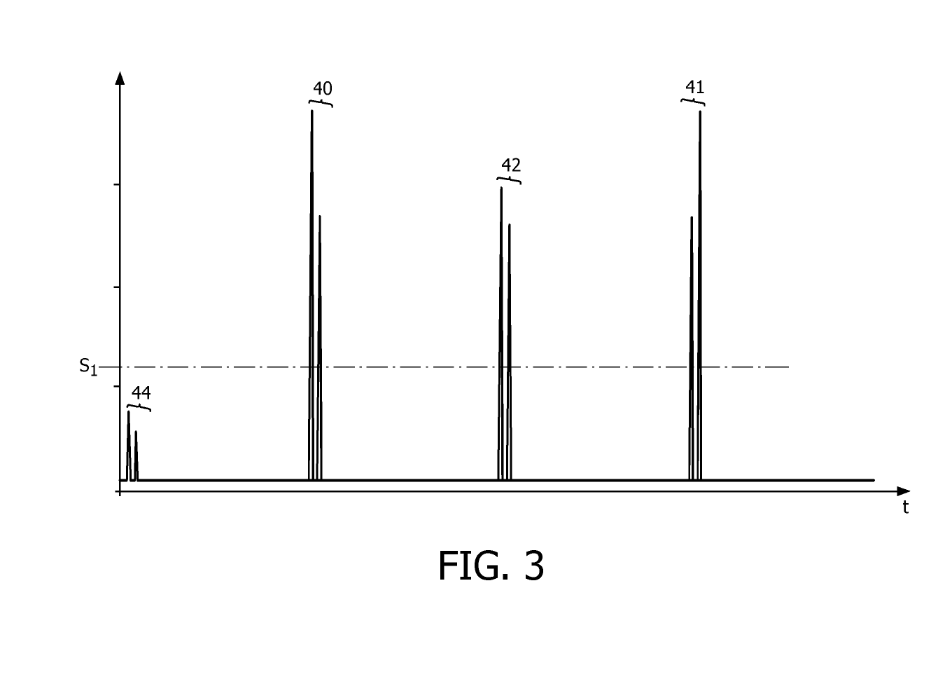

The operation of receiver 6 will now be described with reference to FIGS. 2 and 3.

The OFDM symbol receiving method of FIG. 2 has a coarse synchronization step 30, during which synchronizer 16 computes a coarse position for the FFT-Window and outputs it to transformer 14.

Coarse synchronization may be done according to the method disclosed in patent application WO 2005/002164.

Then, in step 32, transformer 14 performs a Fast Fourier Transform of the received signal during the time interval defined by the FFT-Window and outputs the received OFDM symbols in the frequency domain.

Subsequently, during a phase 34, synchronizer 20 performs a fine symbol synchronization.

At the beginning of phase 34, in step 36, estimator 22 builds the estimated channel impulse response using the scatter pilots present in the symbols output by transformer 14. The estimated channel impulse response represents the channel power characteristic in the time domain in response to a predetermined impulse. Typically, the channel impulse response is computed using an IFFT (Inverse Fast Fourier Transform) within an IFFT-Window. The IFFT-Window is m.

$$\frac{{T}_{u}}{n}$$

wide, where Tᵤ is the duration of the modulation of an OFDM symbol that corresponds to the duration of an OFDM symbol minus the guard interval. m and n are the integers previously defined.

FIG. 3 shows an example of the estimated channel impulse response built by estimator 22 during step 36. The received signal is disrupted by a strong Doppler effect.

Estimated channel impulse response has six high-power peaks corresponding to two channel impulse response replicas 40-41, and a real channel impulse response 42. The high-power peaks of which are higher than a predetermined limit S₁. Replicas 40 and 41 are symmetrically placed on each side of channel response 42 and spaced apart from peaks of channel response 42 by a time interval equal to

$$\frac{{T}_{u}}{n} .$$

FIG. 3 shows also two low-power peaks corresponding to a channel impulse response replica 44. For illustration purposes, the power of peaks of replica 44 is lower than limit S₁.

Peaks of replica 44 are on the left of peaks of replica 40 and are spaced apart from peaks of replica 42 by a time interval equal to

$$m / 2 \frac{{T}_{u}}{n} .$$

Peaks of response 42 are the real peaks corresponding to the real channel impulse response. Peaks of replicas 40, 41 and 44 are ghost peaks corresponding to channel impulse replicas due to Doppler effects, for example.

For illustration purposes, peaks of replicas 40 and 41 have a power higher than peak of response 42. So, in this condition, fine-tuning based on the position of the first high-power peak, i.e. first peak of replica 40, will not work correctly.

Next, it will be assumed that the estimated channel impulse response built during step 36 is the one shown in FIG. 3.

When the estimated channel impulse response has been built, in step 48, tuner 24 verifies the existence of ghost peaks in the estimated channel impulse response. To do so, tuner 24 scans the estimated channel impulse response to detect high power peaks, i.e. power peaks that are higher than limit S₁.

Then, tuner 24 determines if there are high-power peaks which are correlated and which are spaced apart by a multiple of

$$\frac{{T}_{u}}{n} .$$

If so, this means that there are ghost peaks. Otherwise, no ghost peaks are present in the estimated channel impulse response.

Tuner 24 uses the knowledge according to which the structures of the channel impulse response replica and of the real channel impulse response are correlated, which means that their structures are similar. For example, in FIG. 3, each replica 40, 41, 44 and response 42 has two peaks of significant amplitude.

Tuner 24 also uses the teaching according to which each real peak and its corresponding ghost peaks are always spaced apart by a multiple of

$$\frac{{T}_{u}}{n} .$$

Preferably, only one real peak and its corresponding ghost peaks are processed at the same time.

In step 50, if there is no ghost peak, tuner 24 finds the position of the highest power peak in the estimated channel impulse response. Then, tuner 24 fine-tunes, in step 52, the position of the FFT-Window based on the position of this highest power peak.

On the contrary, in step 54, if there are ghost peaks, like in FIG. 3, tuner 24 finds the position of each low-power ghost peak of replica 40 from the position of the highest correlated peaks. Each low-power ghost peak has a power just smaller than the m−1 corresponding highest correlated peaks. The low-power ghost peak corresponds to the peak which is spaced apart from the other m−1 correlated peaks by a multiple of

$$\frac{{T}_{u}}{n}$$

and which has the lowest power. In the case of the estimated channel impulse response of FIG. 3, there are two low-power ghost peaks in replica 44. Note that by determining the position of the low-power peaks according to the position of peaks 40-42, it does not matter whether or not peaks of replica 44 are higher or lower than the predetermined limit S₁. For instance, here, peaks of replica 44 are smaller than limit S₁, so that they are not used during step 48. The power of peaks in replica 44 may be as small as zero. Furthermore, to determine the position of the low-power ghost peaks it does not matter that the peaks of response 42 are smaller than the peaks of replicas 40 and 41.

When the position of the peaks of replica 44 has been found, in step 58, the tuner 24 identifies the position of the real peaks of response 42. In fact, the position of each real peak is spaced apart from the position of the corresponding correlated peak of replica 44 by a predetermined time interval equal to

$$m / 2 \frac{{T}_{u}}{n} .$$

Note that the real peak position lies always within the IFFT-Window. Thus, each real peak position can be found using the following relation:

$${P}_{R} = {P}_{L} + m / 2 \frac{{T}_{u}}{n} mod ( m \frac{{T}_{u}}{n} )$$

where:
P_{R} is the position of one real peak of response 42,
P_{L} is the position of one low-power peak of replica 44, and
mod

$$( m \frac{{T}_{u}}{n} )$$

means that the addition is realized modulo

$$m \frac{{T}_{u}}{n}$$

Once position P_{R} for each real peak is found, in step 60, tuner 24 fine-tunes the position of the FFT-Window based on positions P_{R}.

Steps 32 to 60 may be repeated.

It is important to note that according to present teachings, the real peak position can be found even if there are ghost peaks higher than the real peak.

This method can also be used for erasing the (m−1) ghost peaks for each real peak, so that a standard algorithm can then be applied to the resulting response.

The above receiver and method can be used in any telecommunication system using OFDM modulation and pilots for symbol synchronization.

It is also possible to select among the x highest correlated power peaks, the peak having a position that is centered on an axis of symmetry of the other selected peaks, where x is an odd number greater than or equal to three.

1. A fine OFDM (Orthogonal Frequency Division Multiplexing) symbol synchronization method comprising the steps of:
estimating a channel impulse response from received predetermined pilots present in OFDM symbols, the predetermined pilots being arranged within the OFDM symbol at frequency intervals corresponding to n carrier frequencies, and their positions being shifted by k carrier frequencies from one OFDM symbol to the next, so that m*k=n, m, n and k being integer numbers greater than one, and
fine-tuning the position of a time-domain-to-frequency-domain window used for receiving OFDM symbols, according to the position of at least one power peak in the estimated channel impulse response,
wherein, if there are channel impulse response replicas in the estimated channel impulse response, the positions of correlated power peaks spaced apart by a multiple of
$$\frac{{T}_{u}}{n}$$
is used for finding the position of the at least one power peak used for fine tuning, where Tᵤ is the duration of the modulation of an OFDM symbol.

2. The method according to claim 1, wherein the position of each power peak used for fine tuning is found from the positions of the x highest correlated power peaks, where x is an odd number greater than or equal to three.

3. The method according to claim 1, wherein each power peak used for fine-tuning is found from the position of the smallest correlated power peak that is smaller than the m−1 highest correlated power peaks.

4. The method according to claim 3, wherein the fine-tuning is done according to the following value:
$${P}_{L} + m / 2 \frac{{T}_{u}}{n} mod ( m \cdot \frac{{T}_{u}}{n} )$$
where:
P_{L} is the position of the smallest correlated power peak,
Tᵤ is the duration of the modulation of an OFDM symbol, and
“mod” is the symbol for the “modulo” operation.

5. The method according to claim 1, wherein the method comprises the step of verifying the existence of channel impulse response replicas in the estimated channel impulse response by testing the existence of correlated power peaks spaced apart by a multiple of
$$\frac{{T}_{u}}{n} .$$

6. An OFDM symbol receiving method comprising a coarse OFDM symbol synchronization step, and a fine OFDM symbol synchronization phase according to the method of claim 1.

7. A fine OFDM symbol synchronizer comprising:
a channel impulse response estimator to build an estimated channel impulse response from received predetermined pilots present in OFDM symbols, the predetermined pilots being arranged within the OFDM symbol at frequency intervals corresponding to n carrier frequencies, their positions being shifted by k carrier frequencies from one OFDM symbol to the next, so that m*k=n, m, n and k being integer numbers greater than one, and
a fine-tuner to fine-tune the position of a time-domain-to-frequency-domain window used for receiving OFDM symbols according to the position of at least one power peak in the estimated channel response, wherein the fine-tuner is adapted to use the positions of correlated power peaks spaced apart by a multiple of
$$\frac{{T}_{u}}{n}$$
to find the position of the at least one power peak used for fine-tuning, where Tᵤ is the duration of the modulation of an OFDM symbol.

8. The synchronizer according to claim 7, wherein the fine-tuner is designed to find the position of each correlated power peak used for fine-tuning from the position of the x highest correlated power peaks, where x is an odd number greater than or equal to three.

9. The synchronizer according to claim 7, wherein the fine-tuner is designed to find the position of each correlated power peak used for fine-tuning from the position of the smallest correlated power peak which is smaller than the m−1 highest correlated power peaks.

10. The synchronizer according to claim 9, wherein the fine-tuner is designed to fine-tune according to the following value:
$${P}_{L} + m / 2 \frac{{T}_{u}}{n} mod ( m \cdot \frac{{T}_{u}}{n} )$$
where:
P_{L} is the position of the smallest correlated power peak,
Tᵤ is the duration of the modulation of an OFDM symbol, and
“mod” is the symbol for the “modulo” operation.

11. An OFDM symbol receiver comprising:
a coarse OFDM synchronizer for coarse positioning of a time-domain-to-frequency-domain window used for receiving OFDM symbols, and
a fine OFDM symbol synchronizer according to claim 7 for fine positioning of the time-domain-to-frequency-domain window.
